(19) United States
(12) Patent Application Publication
(10) Pub. No.: US 2018/0230741 A1
(43) Pub. Date: Aug. 16, 2018

(54) CORD WINDING STRUCTURE FOR CORDLESS BLIND

(71) Applicant: Supreme Plastic Products Co., Ltd., Guangdong (CN)

(72) Inventor: SONG-LI ZHENG, Guangdong (CN)

(21) Appl. No.: 15/432,949

(22) Filed: Feb. 15, 2017

(51) Int. Cl. E06B 9/322

(52) U.S. Cl. CPC E06B 9/322

(57) ABSTRACT

A cord winding structure for cordless blind is assembled in a cordless blind. A cord winder includes an upper case and a lower case which are respectively arranged a plurality of columns and posts and combined with each other by bolts. At least one winding wheel for winding a bearing rope, a driving wheel, and a driven wheel arranged corresponding to the driving wheel are assembled to the columns. The driving wheel, the driven wheel, and the winding wheel are respectively formed a gear-like driving portion. The gear-like driving portions of the wheels are engaged with one another. The driving wheel has a gradient coil spring which has different curvatures to result in a front end with weaker elasticity and a rear end with stronger elasticity. The front end of the gradient coil spring is winded on the driven wheel to make the cordless blind correctly be operated.

### FIELD OF THE INVENTION

The present invention relates to a cord winding structure for cordless blind, and more particularly to a cord winder receiving a gradient coil spring with gradient diameters and different curvatures so that the cordless blind may be operated correctly and firmly.

### BACKGROUND OF THE INVENTION

The structure of the conventional cordless blind is shortly described as follows. A bottom end of a headrail is assembled a window covering and a bottomrail which are operated synchronously with the cord. Two sides of a top end of the headrail are respectively fastened a base and a control wheel with a transmission rope. One end of the transmission rope is passed through the control wheel and one end of the cord is passed through the window covering and the bottomrail. The other end of the cord is synchronously winded and fastened to the base. The transmission rope and the cord may be linked to each other. The balance between the transmission rope and the cord may be changed or controlled by hands of a user so that the window covering may be closed or opened.

However, there are some disadvantages described as follows.

Firstly, the base controls the window covering to move up and down though a coil spring. When partial shading is needed, the hand of the user may pull down the bottomrail to extend the window covering downwardly, but the constant elasticity of the coil spring may make it accidental operate to spring back.

Secondly, when the window covering is totally extended, the coil spring needs to support the full weight of the window covering and the bottomrail. The elasticity of the coil spring is not enough to support but needs the hand of the user to pull the bottomrail and the window covering to the headrail. It is not convenient.

In view of the foregoing circumstances, the inventor has invested a lot of time to study the relevant knowledge, compare the pros and cons, research and develop related products. After quite many experiments and tests, the “cord winding structure” of this invention is eventually launched to improve the foregoing shortcomings, to meet the public use.

### SUMMARY OF THE INVENTION

An objective of this invention is providing a cord winding structure for cordless blind. The cord winder includes a gradient coil spring which has different curvatures corresponding to different elasticity so that the cordless blind may be not accidentally operated and quickly opened and closed.

To achieve above objectives, a cord winding structure for cordless blind is assembled in a cordless blind, the cordless blind has a cord winder, at least one set of adjusting device, a headrail, a bottomrail, and more than one window covering, the cord winder is assembled in the headrail, the headrail is used for received a bearing rope, the adjusting device is assembled in the headrail for providing the bearing rope to change direction or rotate, the adjusting device has a linking rod, two bases arranged symmetrically, and a steering rod, the bearing rope is passed through the bases and turned to assemble to the more than one window covering and the bottomrail so that the more than one window covering and the bottomrail are driven by the bearing rope to move up and down, the linking rod is arranged on the headrail and driven by the steering rod to rotate and further to drive the more than one window covering assembled at the bearing rope to open and close, further characterized in that: the cord winder includes an upper case and a lower case, the upper case and the lower case are respectively arranged a plurality of columns and posts, the upper case and the lower case are combined with each other by bolts, at least one winding wheel for winding the bearing rope, a driving wheel, and a driven wheel arranged corresponding to the driving wheel are assembled to the columns, the driving wheel, the driven wheel, and the winding wheel are respectively formed a gear-like driving portion, the gear-like driving portions of the driving wheel, the driven wheel, and the winding wheel are engaged with one another, the driving wheel has a gradient coil spring, the gradient coil spring has a front end with weaker elasticity and a rear end with stronger elasticity, the front end of the gradient coil spring is winded on the driven wheel, the bottomrail is pulled so that the cord winder is released, the driving wheel is rotated so that the gradient coil spring is retracted toward the driven wheel and the cord winder is released.

There are some effects described as follows.

Firstly, when the bottomrail is partially pulled, the cord winder is retracted to the front end thereof so that it may be not sprung back by accidental operation; when the bottomrail is pulled to a bottom end of the cordless blind, the more than one window covering may be closed quickly due to the rear end of the gradient coil spring with stronger elasticity.

Secondly, the at least one winding wheel is defined as a first winding wheel and a second winding wheel, the first winding wheel is engaged with the driving wheel and the second winding wheel is engaged with the driven wheel so that the bearing rope may be retracted and released evenly.

Thirdly, the cord winder is arranged at a center section of the headrail.

Fourthly, the window coverings are slats of a venetian blind.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is an exploded view of a first embodiment of a winding structure of the present invention.

FIG. 2 is a perspective view of the first embodiment of the cord winding structure of the present invention.

FIG. 3 is a perspective view of a cordless blind of the present invention.

FIG. 4 is an operational view of the cordless blind of the present invention.

FIG. 5 is a first operational view of the first embodiment of the cord winding structure of the present invention.

FIG. 6 is a first operational view of the second embodiment of the cord winding structure of the present invention.

FIG. 7 is an exploded view of a second embodiment of the cord winding structure of the present invention.

FIG. 8 is a perspective view of the second embodiment of the cord winding structure of the present invention.

FIG. 9 is a perspective view of a second embodiment of the cordless blind of the present invention.

FIG. 10 is an operational view of the second embodiment of the cordless blind of the present invention.

FIG. 11 is a first operational view of the second embodiment of the cord winding structure of the present invention.

FIG. 12 is a second operational view of the second embodiment of the cord winding structure of the present invention.

### DESCRIPTION OF THE PREFERRED EMBODIMENT

Referring now to the drawings where like characteristics and features among the various figures are denoted by like reference characters.

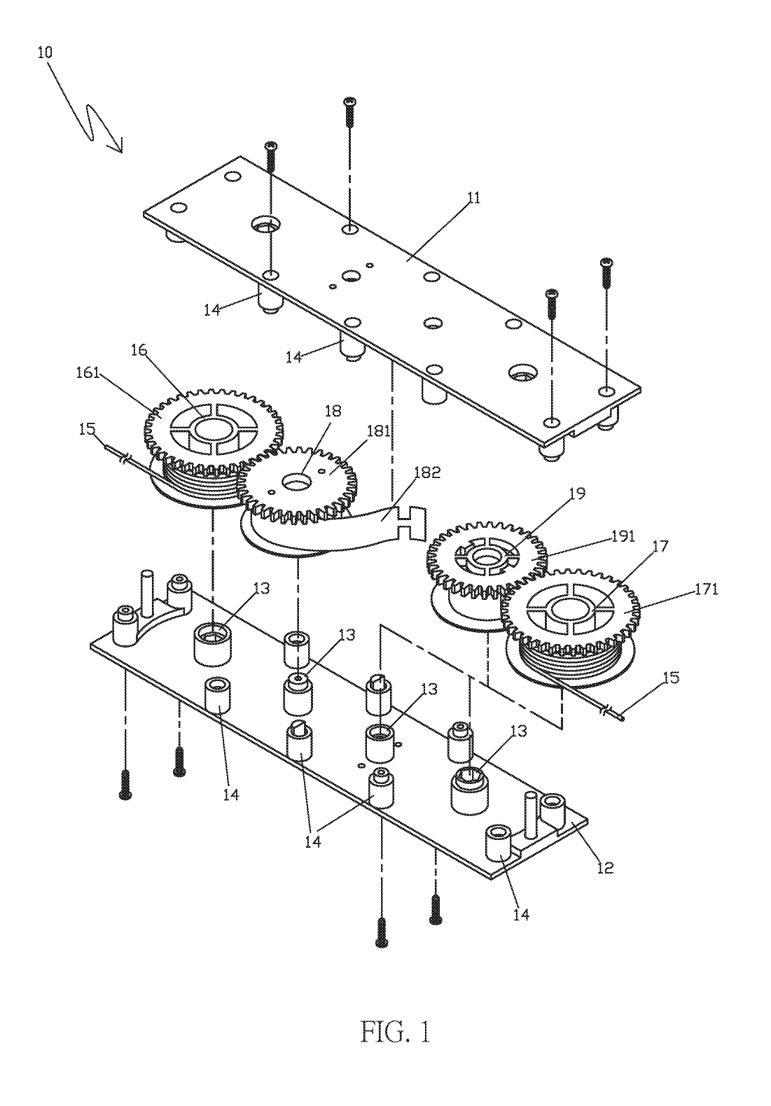

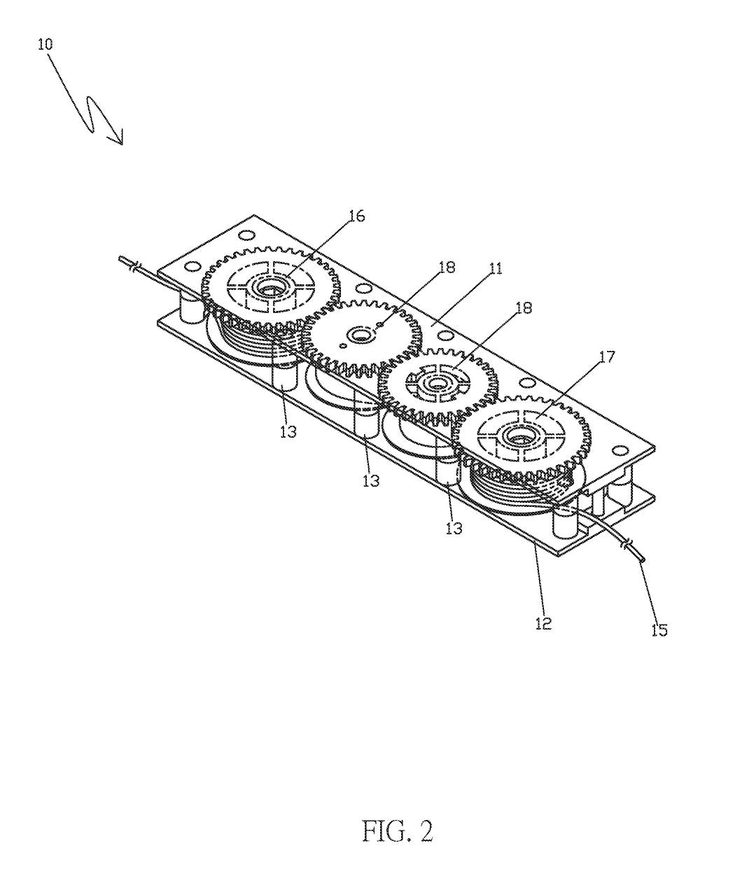

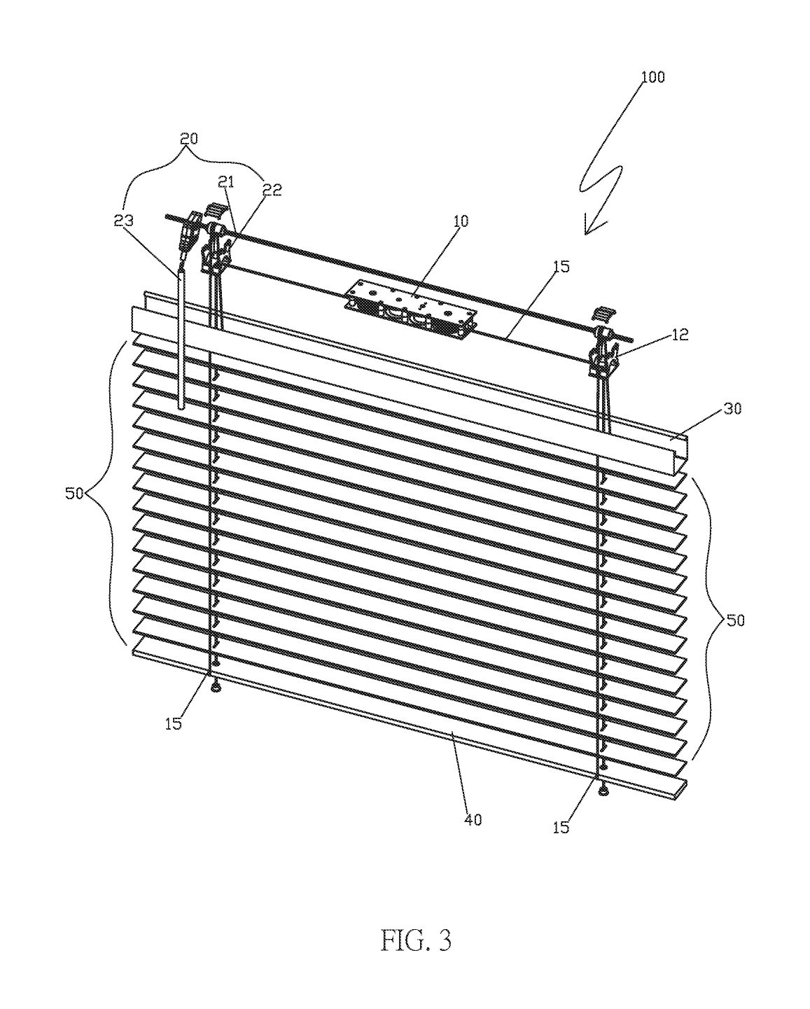

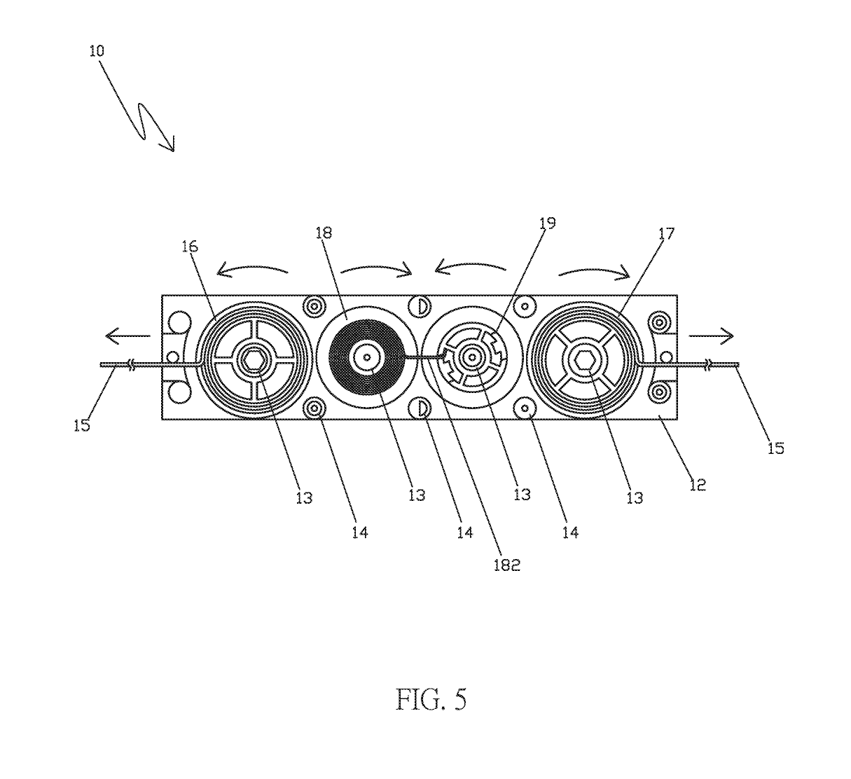

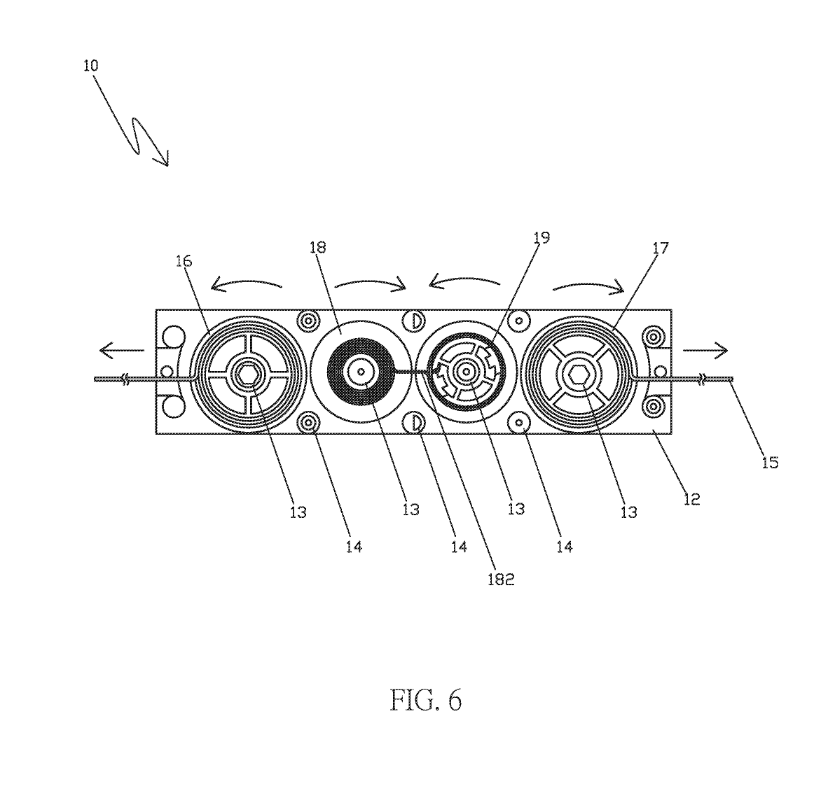

Please refer to FIGS. 1 to 7, a first embodiment of a cord winding structure 100 for cordless blind of the present invention may be assembled in a cordless blind. The cordless blind has the cord winder 10, at least one set of adjusting device 20, a headrail 30, a bottomrail 40, and more than one window covering 50. The window covering 50 may be the slat(s) of a venetian blind. The cord winder 10 is assembled in a center section of the headrail 30. The headrail 30 is used for received a bearing rope 15. The adjusting device 20 is assembled in the headrail 30 for providing the bearing rope 15 to change direction (rotate). The adjusting device 20 has a linking rod 21, two bases 22 arranged symmetrically, and a steering rod 23. The bearing rope 15 is passed through the bases 22 and turned to assemble to the more than one window covering 50 and the bottomrail 40 so that the more than one window covering 50 and the bottomrail 40 are driven by the bearing rope 15 to move up and down. The linking rod 21 is arranged on the headrail 30 and driven by the steering rod 23 to rotate and further to drive the more than one window covering 50 assembled at the bearing rope 15 to open and close.

Please refer to FIGS. 1, 2, 5, and 6, the cord winder 10 includes an upper case 11 and a lower case 12. The upper case 11 and the lower case 12 are respectively arranged a plurality of columns 13 and posts 14. The upper case 11 and the lower case 12 are combined with each other by bolts. A first winding wheel 16 and a second winding wheel 17 which are used for winding the bearing rope 15, a driving wheel 18, and a driven wheel 19 which are arranged corresponding to the driving wheel 18 are assembled to the columns 13. The first winding wheel 16 is engaged with the driving wheel 18 and the second winding wheel 17 is engaged with the driven wheel 19 so that the bearing rope 15 may be retracted and released evenly. The driving wheel 18, the driven wheel 19, the first winding wheel 16, and the second winding wheel 17 are respectively formed a gear-like driving portion 161, 171, 181, 191. The gear-like driving portions 161, 171, 181, and 191 of the driving wheel 18, the driven wheel 19, the first winding wheel 16, and the second winding wheel 17 are engaged with one another. The driving wheel 18 has a gradient coil spring 182. The gradient coil spring 182 has a front end with weaker elasticity and a rear end with stronger elasticity. The front end of the gradient coil spring 182 is winded on the driven wheel 19.

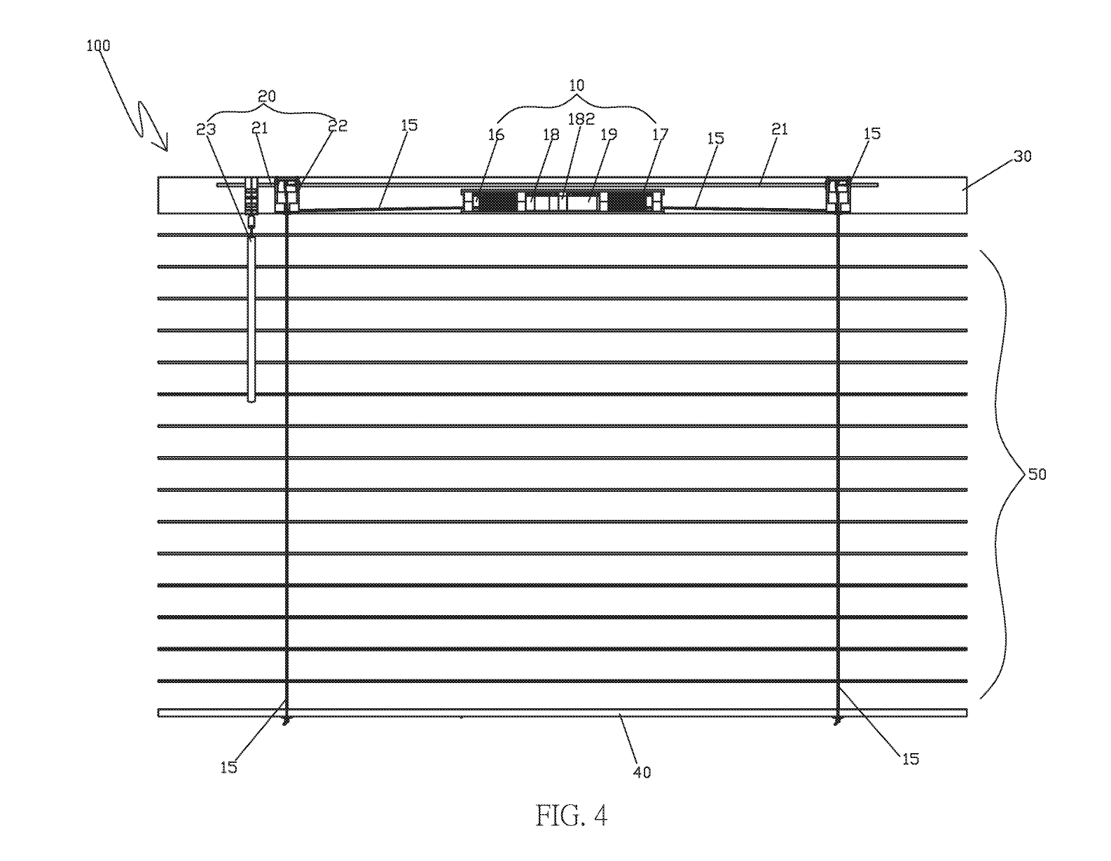

Please refer to FIGS. 4 to 6, in practice, the bottomrail 40 is pulled so that the cord winder 10 is released. The driving wheel 18 is rotated so that the gradient coil spring 182 is retracted toward the driven wheel 19 and the cord winder 10 is released. When the bottomrail 40 is partially pulled, the cord winder 10 is retracted to the front end thereof so that it may be not sprung back by accidental operation. When the bottomrail 40 is pulled to a bottom end of the cordless blind, the more than one window covering 50 may be closed quickly due to the rear end of the gradient coil spring 182 with stronger elasticity.

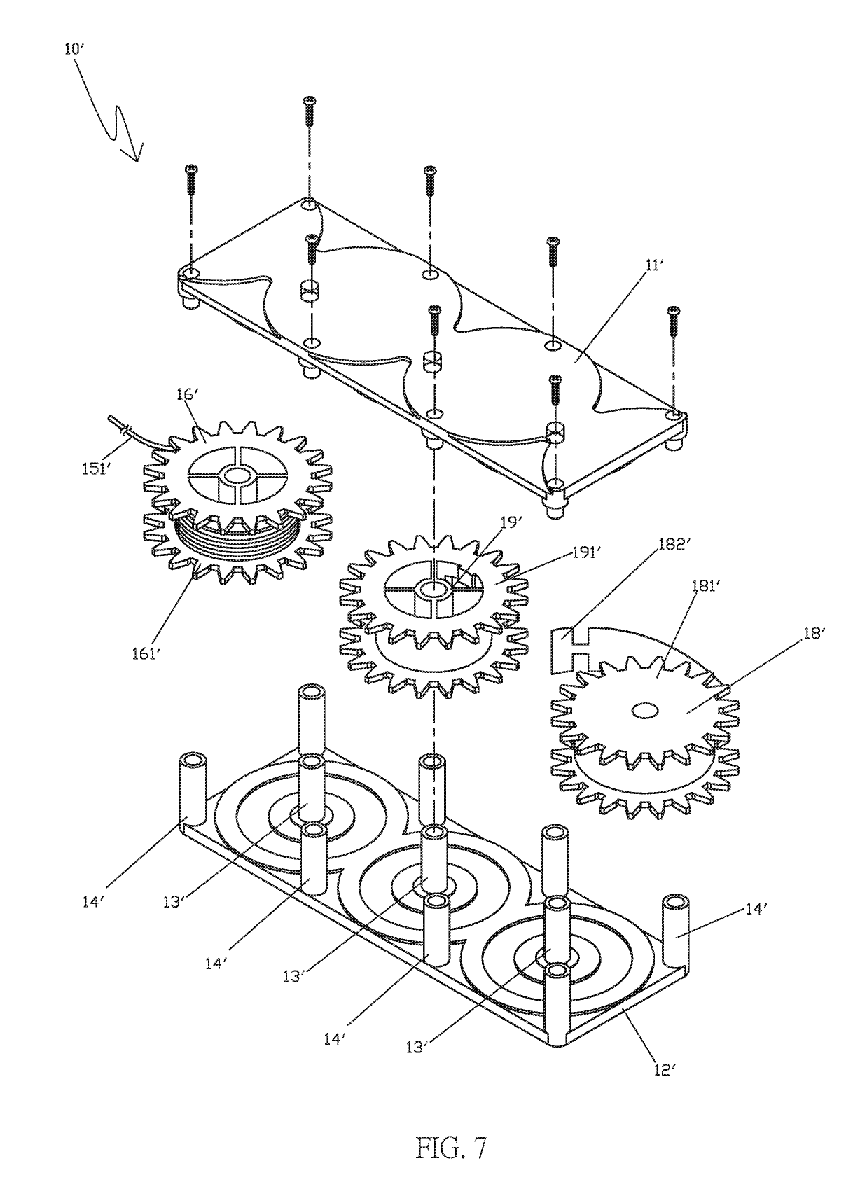

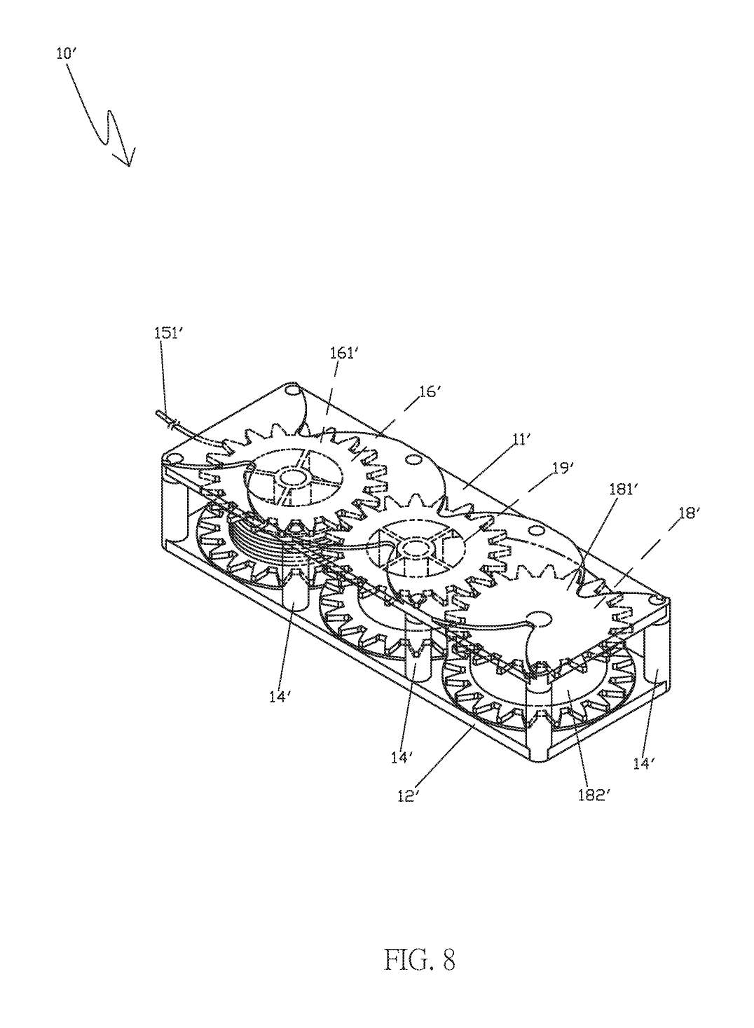

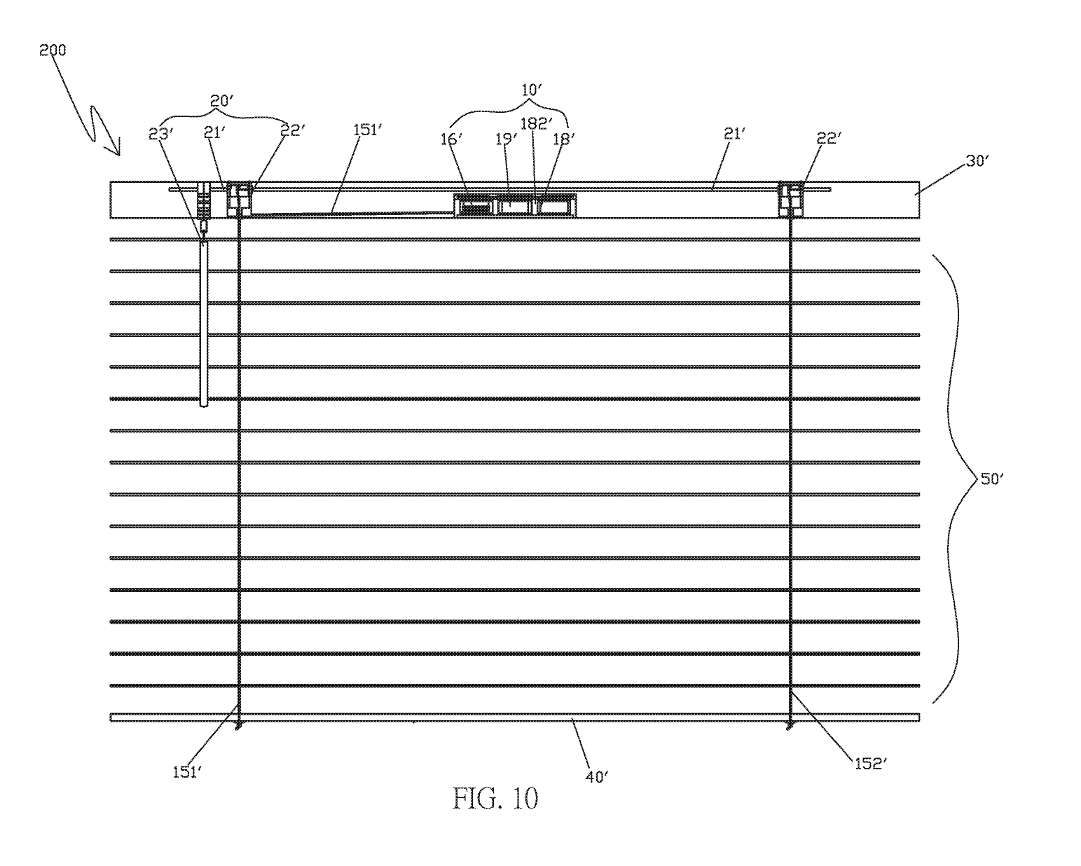

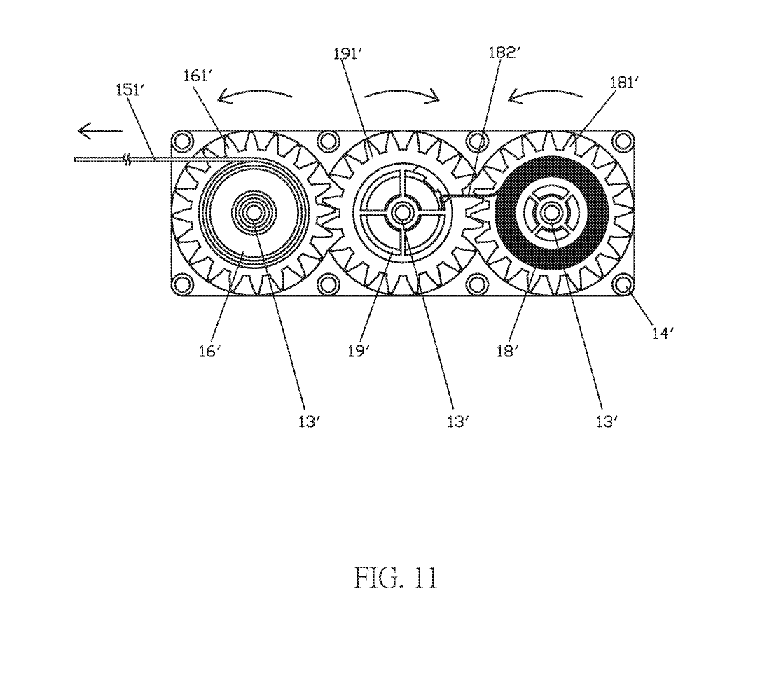

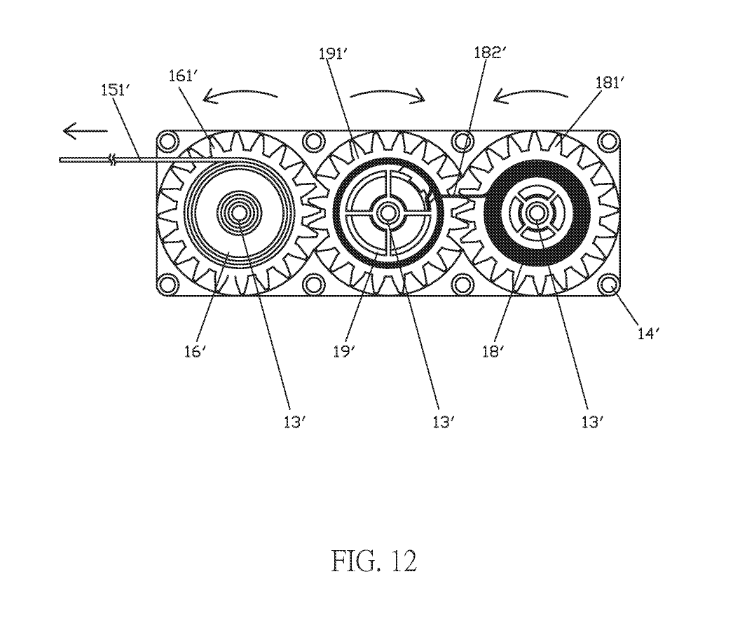

Please refer to FIGS. 7 to 12, a second embodiment of the cord winding structure 200 may be assembled in a cordless blind. The cordless blind has the cord winder 10′, at least one set of adjusting device 20′, a headrail 30′, a bottomrail 40′, and more than one window covering 50′. The window covering 50′ may be the slat(s) of a venetian blind. The cord winder 10′ is assembled in a center section of the headrail 30′. The headrail 30′ is used for received a bearing rope set which is defined as an active bearing rope 151′ and a passive bearing rope 152′. The passive bearing rope 152′ cooperates with the active bearing rope 151′ to perform the acts of moving up and down. The adjusting device 20′ is assembled in the headrail 30′ for providing the active bearing rope 151′ to change direction (rotate). The adjusting device 20′ has a linking rod 21′, two bases 22′ arranged symmetrically, and a steering rod 23′. The active bearing rope 151′ and the passive bearing rope 152′ are passed through the bases 22′ and turned to assemble to the more than one window covering 50′ and the bottomrail 40′ so that the more than one window covering 50′ and the bottomrail 40′ are driven by the active bearing rope 151′ and the passive bearing rope 152′ to move up and down. The linking rod 21′ is arranged on the headrail 30′ and driven by the steering rod 23′ to rotate and further to drive the more than one window covering 50′ assembled at the active bearing rope 151′ and the passive bearing rope 152′ to open and close.

Please refer to FIGS. 7, 8, 11, and 12, the cord winder 10′ includes an upper case 11′ and a lower case 12′. The upper case 11′ and the lower case 12′ are respectively arranged three columns 13′ and a plurality of posts 14′. The upper case 11′ and the lower case 12′ are combined with each other by bolts. A winding wheel 16′ for winding the active bearing rope 151′, a driving wheel 18′, and a driven wheel 19′ which are arranged corresponding to the driving wheel 18′ are assembled to the columns 13′. The driving wheel 18′, the driven wheel 19′, and the winding wheel 16′ are respectively formed a gear-like driving portion 161′, 181′, 191′. The gear-like driving portions 161′, 181′, and 191′ of the driving wheel 18′, the driven wheel 19′, and the winding wheel 16′ are engaged with one another. The driving wheel 18′ has a gradient coil spring 182′. The gradient coil spring 182′ has a front end with weaker elasticity and a rear end with stronger elasticity. The front end of the gradient coil spring 182′ is winded on the driven wheel 19′.

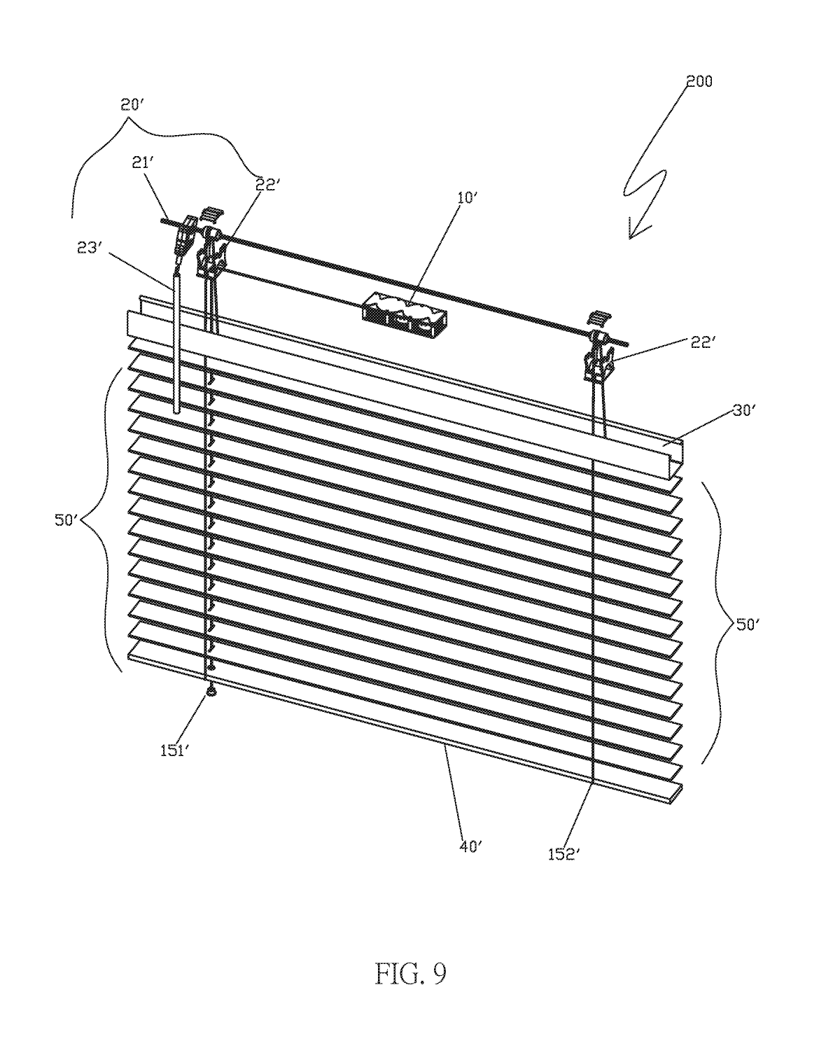

Please refer to FIGS. 9 to 12, in practice, the bottomrail 40′ is pulled so that the cord winder 10′ is released. The driving wheel 18′ is rotated so that the gradient coil spring 182′ is retracted toward the driven wheel 19′ and the cord winder 10′ is released. When the bottomrail 40′ is partially pulled, the cord winder 10′ is retracted to the front end thereof so that it may be not sprung back by accidental operation. When the bottomrail 40′ is pulled to a bottom end of the cordless blind, the more than one window covering 50′ may be closed quickly due to the rear end of the gradient coil spring 182′ with stronger elasticity.

In addition, each of the gradient coil springs 182, 182′ is mainly composed of a sheet. The sheet is machined by working machine to form gradient diameters and different curvatures so that the gradient coil springs 182 and 182′ have gradient elasticity. For example, the diameter of the front end of the gradient coil spring 182, 182′ is 12.5 cm and the diameter of the rear end of the gradient coil spring 182, 182′ is 13.5 cm. And the front end and the rear end of the gradient coil spring 182, 182′ are jointed tangentially by an arc whose diameter is 30 cm. Therefore, the gradient coil spring 182, 182′ has different curvatures for each section so that the cordless blind may be operated correctly.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A cord winding structure for cordless blind, assembled in a cordless blind, the cordless blind has a cord winder, at least one set of adjusting device, a headrail, a bottomrail, and more than one window covering, the cord winder is assembled in the headrail, the headrail is used for received a bearing rope, the adjusting device is assembled in the headrail for providing the bearing rope to change direction or rotate, the adjusting device has a linking rod, two bases arranged symmetrically, and a steering rod, the bearing rope is passed through the bases and turned to assemble to the more than one window covering and the bottomrail so that the more than one window covering and the bottomrail are driven by the bearing rope to move up and down, the linking rod is arranged on the headrail and driven by the steering rod to rotate and further to drive the more than one window covering assembled at the bearing rope to open and close, further characterized in that:
the cord winder includes an upper case and a lower case, the upper case and the lower case are respectively arranged a plurality of columns and posts, the upper case and the lower case are combined with each other by bolts, at least one winding wheel for winding the bearing rope, a driving wheel, and a driven wheel arranged corresponding to the driving wheel are assembled to the columns, the driving wheel, the driven wheel, and the winding wheel are respectively formed a gear-like driving portion, the gear-like driving portions of the driving wheel, the driven wheel, and the winding wheel are engaged with one another, the driving wheel has a gradient coil spring, the gradient coil spring has a front end with weaker elasticity and a rear end with stronger elasticity, the front end of the gradient coil spring is winded on the driven wheel, the bottomrail is pulled so that the cord winder is released, the driving wheel is rotated so that the gradient coil spring is retracted toward the driven wheel and the cord winder is released;
when the bottomrail is partially pulled, the cord winder is retracted to the front end thereof so that it may be not sprung back by accidental operation; when the bottomrail is pulled to a bottom end of the cordless blind, the more than one window covering may be closed quickly due to the rear end of the gradient coil spring with stronger elasticity.

2. The cord winding structure as claimed in claim 1, wherein the at least one winding wheel is defined as a first winding wheel and a second winding wheel, the first winding wheel is engaged with the driving wheel and the second winding wheel is engaged with the driven wheel so that the bearing rope may be retracted and released evenly.

3. The cord winding structure as claimed in claim 1, wherein the cord winder is arranged at a center section of the headrail.

4. The cord winding structure as claimed in claim 1, wherein the window coverings are slats of a venetian blind.
